(19) United States
(12) Patent Application Publication
(10) Pub. No.: US 2004/0255041 A1
(43) Pub. Date: Dec. 16, 2004

(54) System and method for multimedia messages interchange between different communication interfaces

(76) Inventors: Shih-Li Wen, Taipei (TW); Hsiang-Min Liu, Taipei (TW); Chie-Chien Chien, Taipei (TW); I-Ping Hu, Taipei (TW)

Correspondence Address: BIRCH STEWART KOLASCH & BIRCH, PO BOX 747, FALLS CHURCH, VA, 22040-0747, US

(21) Appl. No.: 10/459,449

(22) Filed: Jun. 12, 2003

(51) Int. Cl. G06F 15/16

(52) U.S. Cl. 709/231; 709/246

(57) ABSTRACT

With the system and method for multimedia message interchange between different communication interfaces, the master server end receives a multimedia message through the numeral buttons and communication interface of the transmitting end, and the format of the multimedia message is converted to make the message usable after the receiving ends of different communication interfaces receive it. Thus the multimedia message is interchanged between different communication interfaces.

### BACKGROUND OF THE INVENTION

1. Field of Invention

The invention relates to a system and method for message interchange, and especially to interchange multimedia messages between different communication interfaces with numeral buttons.

2. Related Art

With the gradually increasing requirement of message transmission, a variety of methods for transmission have been developed, which can be roughly divided into two types—cable and wireless.

Cable transmission includes Email or instant message interchange software (such as ICQ, MSN Messenger Service etc.), among which Email is complicated in setting and operation, but with better multimedia performance. Generally the instant message interchange software is easy to operate, but various settings for levels of complexity and multimedia performance.

Wireless transmission includes SMS, EMS, MMS and WAP etc., which will be introduced below:

1. Short Message Service (SMS): After the user enters short messages, SMS delivers the message to another person, but the number of words must be considered to avoid transmitting too many words. The word input is inconvenient as the input is achieved mainly by pressing buttons one by one. Another shortcoming of SMS is that no multimedia performance is involved.

2. Enhanced Message Service (EMS): This is similar to SMS, except transmissions of pictures as well as words are included. EMS has the same shortcomings as SMS, such as words limits, inconvenient operation and no multimedia performance.

3. Multimedia Message Service (MMS): This is useful for transmitting pictures, music and words (namely, multimedia performance), but is still limited by number of words and inconvenient operation, and is available only after being connected with a network.

4. Wireless Applications Protocol (WAP): This has multimedia performance but with limited capacity and the requirement of connecting to a network in advance.

Although there are several methods for message transmission in the market, they cannot interchange messages and most of the above methods do not provide multimedia performance. They have such complicated operations that automatic processing of software or systems is impossible. So it is very important to develop a system and method for multimedia message interchange between different transmission types by numeral buttons.

### SUMMARY OF THE INVENTION

A goal of the invention is to provide a system and method for multimedia message transmission between different communication interfaces.

The system for multimedia message interchange between different communication interfaces of the invention mainly includes a transmitting end and a master server end. An communication interface is installed in the transmitting end for transmitting multimedia messages, which transmits to the master server end in some format the entered multimedia file, the transmitting target and the reception mode. The master server end includes a plurality of servers, an analyzing unit and a converting unit, responsible for multimedia message transmission, message format analysis and message format conversion respectively. After the master server end receives the multimedia message, the analyzing unit starts to analyze its format, the converting unit converts the format according to the reception mode, and then the multimedia message is transmitted to the transmitting target through the server corresponding to the format. Therefore multimedia messages are interchanged between different communication interfaces.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow illustration only, and thus are not limitative of the invention, and wherein:

FIG. 1 shows a system of the invention; and

FIGS. 2A and 2B show a flowchart of the invention.

### DETAILED DESCRIPTION OF THE INVENTION

The system and method of the invention is used for multimedia message interchange between different communication interfaces.

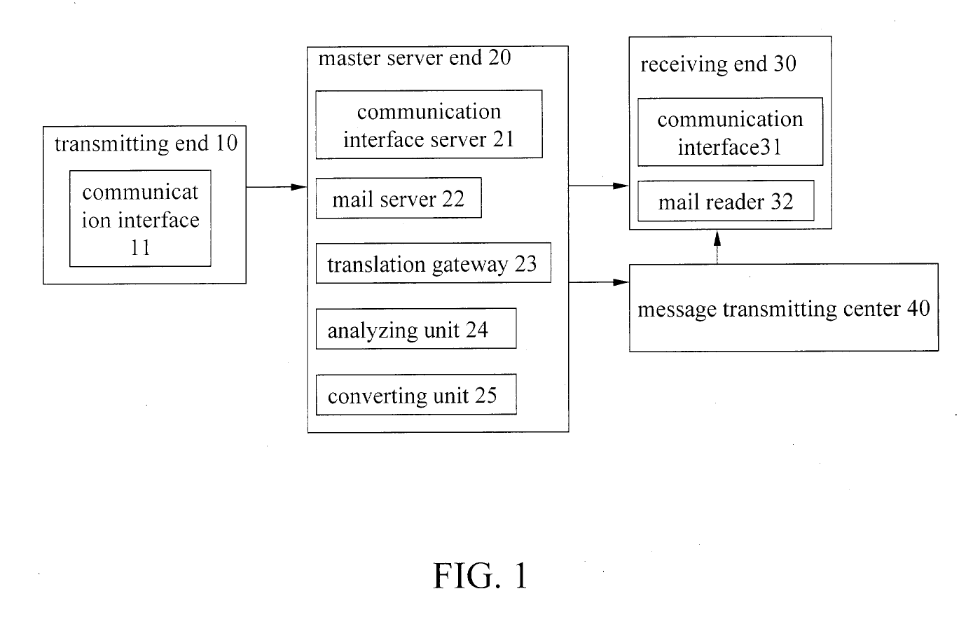

Referring to FIG. 1, the system for different communication interfaces exchanging multimedia messages includes a transmitting end 10, a master server end 20 and a receiving end 30. The transmitting end 10 transmits multimedia messages to the receiving end 30, but the master server end 20 receives multimedia messages prior to the receiving end 30 and converts their format so that the receiving end 30 receives the message.

The communication interface 11 for multimedia message interchange is installed in the transmitting end 10. After the user enters the multimedia file (including any sounds, videos, words and pictures), the transmitting target and the reception mode, the communication interface 11 transmits the multimedia message to the master server end 20 in some format.

The master server end 20 is composed of a plurality of servers (including a communication interface server 21, a mail server 22 and a translation gateway 23), an analyzing unit 24 and a converting unit 25. The servers are to transmit multimedia messages, the analyzing unit 24 analyzes their format, and the converting unit 25 converts them. Then after the master server end 20 receives a multimedia message, the analyzing unit 24 analyzes its format and the converting unit 25 converts the format according to the reception mode. Thus the multimedia message is transmitted to the transmitting target from the server corresponding to its format.

The receiving end 30 receives the multimedia message. It is equipped with a communication interface 31 (similar to the communication interface 11 of the transmitting end 10) or a mail reader 32, or is a mobile phone. When the receiving end 30 functions as a communication interface 31, the corresponding server is the communication interface server 21. Therefore the multimedia message is transmitted by the communication interface server 21, and opened by the communication interface 31 after the receiving end 30 receives it. When the receiving end 30 is a mail reader 32, the corresponding server is the mail server 22. So the multimedia message is transmitted at the mail server 22, and opened by the mail reader 32 after the receiving end 30 receives it. When the receiving end 30 is a mobile phone, the multimedia message is received from a message transmitting center 40, and then transmitted to receiving end 30 with the corresponding server being the translation gateway 23. Therefore, after the translation gateway 23 transmits the multimedia message to the message transmitting center 40, the message is transmitted from the message transmitting center 40 to the receiving end 30, and received by the receiving end 30.

So after the multimedia file, the transmitting target and the reception mode are entered into the multimedia message at the transmitting end 10, the message is transmitted to the master server end 20 in some format from the communication interface 11. The master server end 20 then receives the multimedia message, the analyzing unit 24 analyzes its format, the converting unit 25 converts the format according to the reception mode, and the message is transmitted to the transmitting target from the server corresponding to the format of the message. Certainly the reception mode is one of the selections within reception of the communication interface 31, the mail reader 32 and the mobile phone. When received by the communication interface 31, the multimedia message is not converted into any other format by the converting unit 25 and is transmitted by the communication interface server 21. When received by the mail reader 32, the multimedia message is converted into a format suitable for the mail reader 32, and transmitted by the mail server 22. When received by the mobile phone, the multimedia message is converted into a format suitable for a mobile phone by the converting unit 25 and is transmitted by the translation gateway 2.

When the receiving end 30 receives the message with the communication interface 31, the multimedia message may be opened. When the receiving end 30 receives the message with the mail reader 32, the multimedia message is opened similarly. When the receiving end 30 receives the message with the mobile phone, the multimedia message is not forwarded to the receiving end 30 until it first passes the multimedia message transmitting center 40.

With the above description it is clear that the invention makes it possible to exchange messages between different communication interfaces.

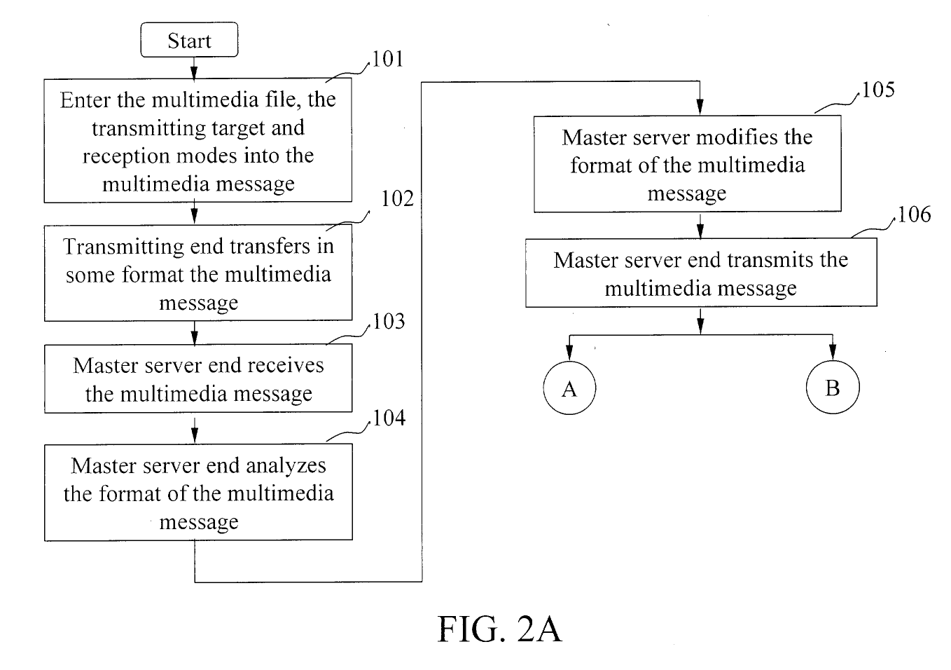

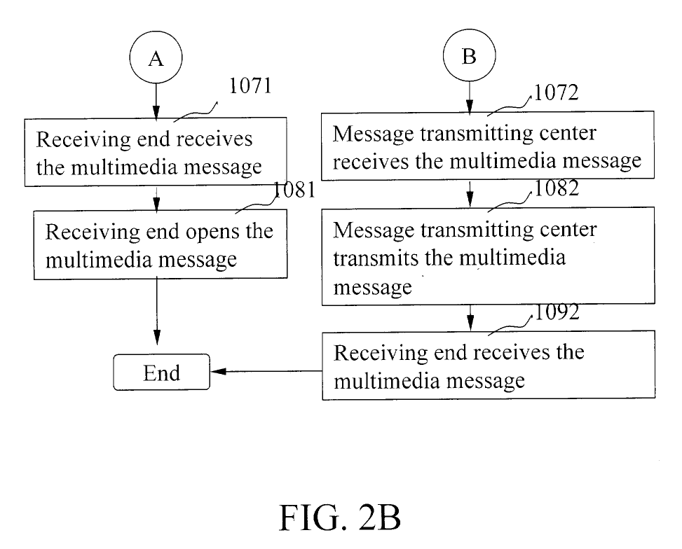

Referring to FIGS. 2A and 2B, the method for multimedia message transmission between different communication interfaces of the invention including the following steps:

When the multimedia file, the transmitting target and reception modes are entered into the multimedia message (step 101), the multimedia file is selected as either voice, video, words or pictures, and the inputting of the multimedia file, the transmitting target and the reception mode is done by pressing the same or different numeral buttons.

The transmitting end transfers in some format the multimedia message (step 102), which includes the multimedia file, the transmitting target and the reception mode.

The master server end made up of a plurality of servers receives the multimedia message (step 103).

The master server end analyzes the format of the multimedia message (step 104).

The master server modifies the format of the multimedia message according to the reception mode of the multimedia message (step 105).

The multimedia message is transmitted to the transmitting target by the master server end through the server corresponding to the format (106).

Afterwards, two types of flows are applied, namely, when the multimedia message is being received at the receiving end with the communication interface or mail reader, the receiving end receives the message (step 1071) and opens it (step 1081). Step 1081 could be divided into two parts: the multimedia message is opened with the communication interface when received, and the message is opened with the mail reader when received. When the message is received with the mobile phone at the receiving end, the message transmitting center is used to continue the reception of the message (step 1072), the message is then transferred into the multimedia message by the message transmitting center transmit (step 1082), and the multimedia message is received by the receiving end (step 1092).

The above description shows that the invention makes possible the interchange of multimedia messages between different communication interfaces.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system for interchanging multimedia messages between different communication interfaces, which comprises:
a transmitting end, equipped with a communication interface for message transmission, after pressing numeral buttons to enter a multimedia file, a transmitting target and a reception mode into a multimedia message, the communication interface transmitting the multimedia message in some format; and
a master server end, equipped with a plurality of servers, an analyzing unit, and a converting unit, responsible for multimedia message transmission, message format analysis and format conversion respectively, after the master server end receiving the multimedia message, the analyzing unit analyzing its format, and the converting unit modifying the format according to the reception mode, at the same time, the multimedia message transmitted to the transmitting target by the server corresponding to the message format.

2. The system of claim 1, wherein the multimedia file is selected from the group consisting of voice, videos, words and pictures.

3. The system of claim 1, wherein the multimedia file, the transmitting target, and the reception mode is entered into the multimedia message by pressing the different numeral buttons.

4. The system of claim 1 further comprises a receiving end to receive the multimedia message.

5. The system of claim 4 further comprises a message transmitting center, the receiving end is a mobile phone, and the server is a conversion gateway, after being transmitted by the server and received by the message transmitting center, the multimedia message being transmitted to the receiving end.

6. The system of claim 4, wherein the receiving end comprises a mail reader, the server is a mail server for transmission of the multimedia message, and the mail reader opens the multimedia message after the receiving end gets the message.

7. The system of claim 4, wherein the receiving end comprises a communication interface, which is identical to the communication interface of the transmitting end, and the server is a communication interface server therein the multimedia message is transmitted, after the receiving end receives the multimedia message, the communication interface opens the multimedia message.

8. A method for multimedia messages interchange between different communication interfaces, the method comprises the steps of:
transmitting in a format a multimedia message, which comprises a multimedia file, a transmitting target and a reception mode, by a transmitting end;
receiving the multimedia message by a master server which comprises a plurality of severs;
analyzing the format of the multimedia message by the master server;
modifying the format of the multimedia message according to the reception mode by the master end; and
transmitting the multimedia message to the transmitting target by the master server through the server corresponding to the format of the multimedia message.

9. The method of claim 8, wherein the multimedia file is selected from the group consisting of voice, videos, words and pictures.

10. The method of claim 8 further comprises a step of entering the multimedia file, the transmitting target and the reception mode into the multimedia message, before the step of transmitting in a format a multimedia message.

11. The method of claim 10, wherein the multimedia file, the transmitting target, and the reception mode enters into the multimedia message by pressing different numeral buttons.

12. The method of claim 8 further comprises a step of receiving the multimedia message by a receiving end, after the step of transmitting the multimedia message to the transmitting target by the master server through the server corresponding to the format of the multimedia message.

13. The method of claim 12 further comprises a step of opening the multimedia message by a mail reader of the receiving end, after the step of receiving the multimedia message by a receiving end.

14. The method of claim 12 further comprises a step of opening the multimedia message by a communication interface of the receiving end, after the step of receiving the multimedia message by a receiving end.

15. The method of claim 8 further comprises following steps, after the step of transmitting the multimedia message to the transmitting target by the master server through the server corresponding to the format of the multimedia message:
receiving the multimedia message by a message transmitting center;
transmitting the multimedia message by the message transmitting center; and
receiving the multimedia message by a receiving end.
